(19) United States
(12) Patent Application Publication
(10) Pub. No.: US 2016/0360385 A1
(43) Pub. Date: Dec. 8, 2016

(54) MULTI-TERMINAL-BASED MESSAGE PUSHING METHOD AND DEVICE

(71) Applicant: LE SHI INTERNET INFORMATION TECHNOLOGY CORP., BEIJING, Beijing (CN)

(72) Inventor: Jianjun YANG, Beijing (CN)

(21) Appl. No.: 15/244,850

(22) Filed: Aug. 23, 2016

Related U.S. Application Data
(63) Continuation of application No. PCT/CN2015/080110, filed on May 28, 2015.

(30) Foreign Application Priority Data
May 30, 2014 (CN) 201410240570.8

(51) Int. Cl. H04W 4/12

(52) U.S. Cl. CPC H04W 4/12; H04W 80/12

(57) ABSTRACT

Provided is a multi-terminal-based message pushing method and device. The method includes: in the case of reading a push message, sending, by a current terminal, a message for acquiring information about the current terminal to an information server, wherein the push message carries a file; receiving the information about the current terminal which is sent by the information server; and according to the received information about the current terminal, in the case where the file carried in the push message is read by the current terminal effectively, returning an effective reading identifier to the information server, so that the information server cancels unread reminder of the push message for other terminals.

### CROSS-REFERENCE TO RELATED APPLICATIONS

The present disclosure is a continuation of International Application No. PCT/CN2015/080110 filed on May 28, 2015, which is based upon and claims priority to Chinese Patent Application No. 201410240570.8, entitled “MULTI-TERMINAL-BASED MESSAGE PUSHING METHOD AND DEVICE”, filed on May 30, 2014, the entire contents of all of which are incorporated herein by reference.

### TECHNICAL FIELD

The present disclosure relates to the technical field of push, and in particular, to a multi-terminal-based message push method and device.

### BACKGROUND

Along with development of mobile internet, a user can work with multiple terminals at the same time, for example, a smart phone, a computer, a tablet personal computer and the like. When multiple terminals of the user simultaneously receives a push message and the push message carries a file, a current terminal reads the push message and downloads the file carried by the push message. To prevent too many push messages, unread reminder of the push message to other terminals shall be canceled when the current terminal is downloading the file carried by the push message. However, if the current terminal cannot effectively read the file carried by the push message, since the unread reminder of other terminals which is capable of effectively reading the file carried by the push message has already been cancelled, the file carried by the push message cannot be effectively read, and complexity in effectively reading the file carried by the push message is increased.

### SUMMARY

For the purpose, the present disclosure discloses a multi-terminal-based message push method and device, and aims to solve the problem of high complexity in effectively reading a file carried by a push message in the prior art.

The embodiment of the present disclosure provides a multi-terminal-based message pushing method, including:

in the case of reading a push message, sending, by a current terminal, a message of acquiring information of the current terminal to an information server, wherein the push message carries a file;

receiving information of the current terminal sent by the information server;

feeding back an effectively-read identifier to the information server according to the received information of the current terminal in the case that the file carried by the push message is effectively read by the current terminal, so as to make the information server cancel unread reminder of the push message to other terminals.

The embodiment of the present disclosure provides an electronic device for multi-terminal-based message pushing, including at least one first processor; and a first memory communicably connected with the at least one first processor for storing instructions executable by the at least one first processor, wherein execution of the instructions by the at least one first processor causes the at least one first processor to:

send a message of acquiring information of a current terminal to an information server when the current terminal is reading a push message, wherein the push message carries a file;

receive the information of the current terminal sent by the information server;

feed back an effectively-read identifier to the information server according to the received information of the current terminal in the case that the file carried by the push message is effectively read by the current terminal, so as to make the information server cancel unread reminder of the push message to other terminals.

The embodiment of the present disclosure further provides a computer program, including computer readable codes, wherein the computer readable codes enable a mobile terminal to execute the multi-terminal-based message pushing method at the terminal side in the embodiment of the present disclosure when being operated on the mobile terminal.

The embodiment of the present disclosure further provides a computer readable medium in which the computer program is stored.

The embodiment of the present disclosure further provides another multi-terminal-based message pushing method, including: acquiring, by an information server, a message which is sent from a current terminal when reading a push message for acquiring information of the current terminal, wherein the push message carries a file; sending, by the information server, the information of the current terminal to the current terminal; receiving, by the information server, an effectively-read identifier fed back from the current terminal, and cancelling unread reminder of the push message to other terminals, wherein the effectively-read identifier is fed back to the information server from the current terminal according to the received information of the current terminal in the case that the file carried by the push message is effectively read by the current terminal.

The embodiment of the present disclosure further provides another electronic device for multi-terminal-based message pushing, including at least one second processor; and a second memory communicably connected with the at least one second processor for storing instructions executable by the at least one second processor, wherein execution of the instructions by the at least one second processor causes the at least one second processor to: acquire a message sent from a current terminal when reading a push message for acquiring information of the current terminal, wherein the push message carries a file; send the information of the current terminal to the current terminal; receive an effectively-read identifier fed back from the current terminal, and cancel unread reminder of the push message to other terminals, wherein the effectively-read identifier is fed back to the information server from the current terminal according to the received information of the current terminal in the case that the file carried by the push message is effectively read by the current terminal.

The embodiment of the present disclosure further provides a computer program, including computer readable codes, wherein the computer readable codes enable a server to execute the multi-terminal-based message pushing method at the server side in the embodiment of the present disclosure when being operated on the server.

The embodiment of the present disclosure further provides a computer readable medium in which the computer program is stored.

The embodiment of the present disclosure provides a multi-terminal-based message pushing method and device. As the information of the current terminal is acquired, whether the current terminal is capable of effectively reading the file carried by the push message is determined, and the unread reminder of the push message to other terminals is cancelled under the condition that the current terminal is capable of effectively reading the file carried by the push message, effectively-read complexity can be decreased.

### BRIEF DESCRIPTION OF DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows the flow chart of the multi-terminal-based message pushing method provided by the embodiment of the present disclosure.

FIG. 2 shows the flow chart of another multi-terminal-based message pushing method provided by the embodiment of the present disclosure.

FIG. 3 shows the schematic diagram of user login procedures provided by the embodiment of the present disclosure.

FIG. 4 shows the flow chart of a third multi-terminal-based message pushing method provided by the embodiment of the present disclosure.

FIG. 5 shows the structural schematic diagram of the multi-terminal-based message pushing device provided by the embodiment of the present disclosure.

FIG. 6 shows the structural schematic diagram of another multi-terminal-based message pushing device provided by the embodiment of the present disclosure.

FIG. 7 schematically illustrates a block diagram of a terminal for executing the method according to the present disclosure.

FIG. 8 schematically illustrates a block diagram of an information server for executing the method according to the present disclosure.

### DETAILED DESCRIPTION

According to the prior art, when multiple terminals of a user receive a push message at the same time, a current terminal may read the push message, and after the current terminal reads the push message, unread reminder of the push message to other terminals is cancelled. However, in the solution, the push message is pushed to the current terminal no matter whether the current terminal is able to effectively read the push message, so that the push message cannot be effectively read.

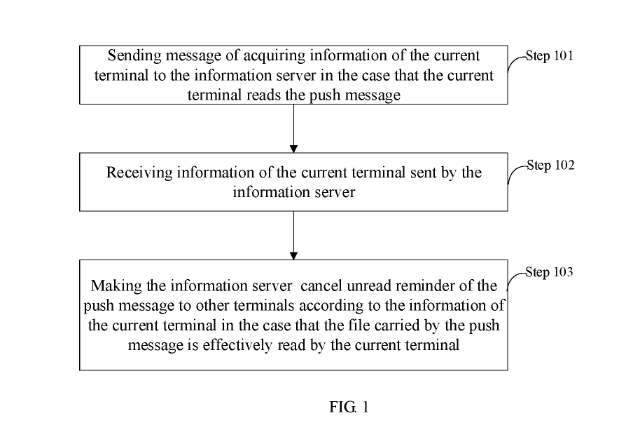

As shown in FIG. 1, to address the problem, the embodiment of the present disclosure provides a multi-terminal-based message pushing method, including steps as follows.

In step 101, in the case of reading a push message by a current terminal, a message of acquiring information of the current terminal is sent to an information server, wherein the push message carries a file.

In step 102, information of the current terminal sent by the information server is received.

In step 103, an effectively-read identifier is fed back to the information server according to the received information of the current terminal in the case that the file carried by the push message is effectively read by the current terminal, so as to make the information server cancel unread reminder of the push message to other terminals.

According to the solution, as the information of the current terminal is acquired, whether the current terminal is capable to effectively read the file carried by the push message is determined, and the unread reminder of the push message to other terminals is cancelled under the condition that the current terminal is capable of effectively reading the file carried by the push message, effectively-read complexity may be decreased.

The technical solutions in the embodiments of the present disclosure are clearly and completely described with the following figures in the embodiments of the present disclosure, and obviously, the described embodiments are not all but a part of the embodiments of the present disclosure. Based on the embodiments of the present disclosure, other embodiments obtained by an ordinary person skilled in the art without creative work are within the protection scope of the present disclosure.

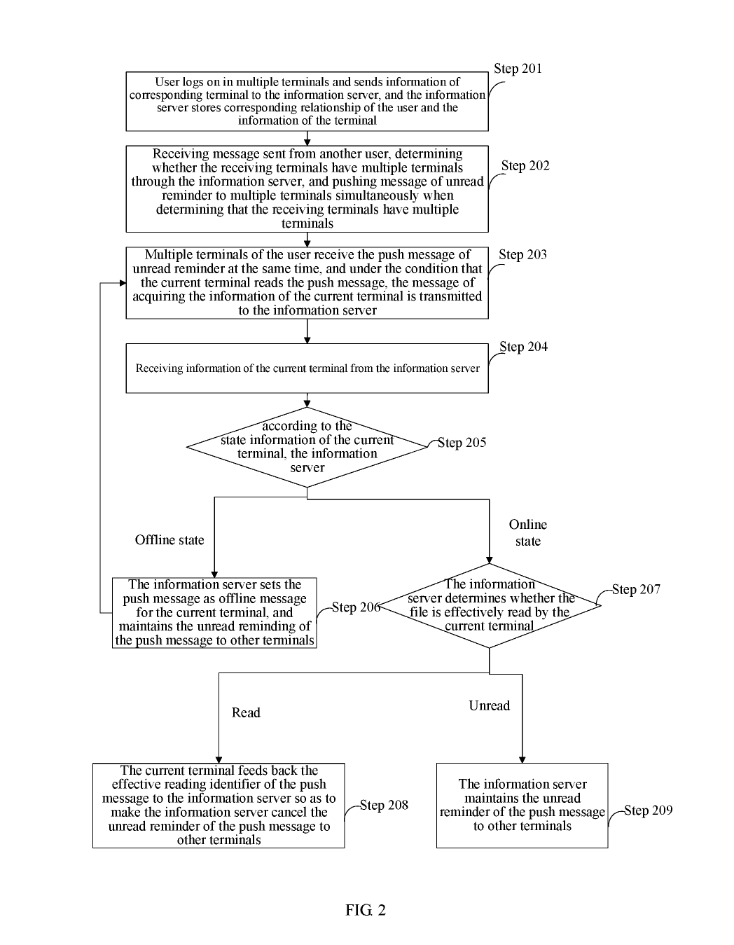

As shown in FIG. 2, the multi-terminal-based message pushing method provided by the embodiments of the present disclosure on the basis of the solution is described in details. The multi-terminal-based message pushing method specifically includes the steps as follows.

In step 201, a user logs on with multiple terminals and sends information of a corresponding terminal to an information server, and the information server stores corresponding relationship of the user and the information of the current terminal.

In the embodiment of the present disclosure, the multiple terminals include one or more of a mobile terminal, a personal computer and a personal digital assistant. The information sent to the information server, of the corresponding terminal includes state information and capability information, wherein the state information includes terminal online or terminal offline; the capability information is used for indicating whether the terminal has the capability of effectively reading the file carried in the received push message. In addition, the information of the terminal further includes identification information of the terminal, and the identification information of the terminal may be used to confirm uniqueness of each terminal in a network.

In addition, the information sent to the information server, of the corresponding terminal may further include equipment information, wherein the equipment information includes a terminal model, a terminal name, an operating system, and the like.

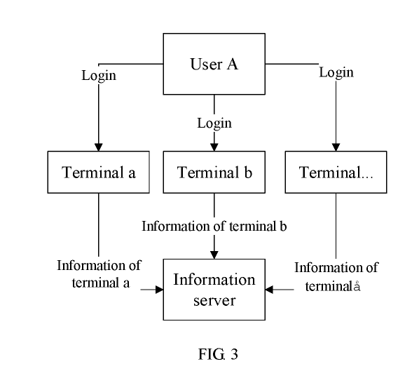

FIG. 3 shows the schematic diagram of user login procedures provided by the embodiment of the present disclosure.

A user A logs on in a terminal a, a terminal b, . . . , after login success, each terminal sends respective information to the information sever, and the information server stores the received information of the terminals.

Table 1 shows the corresponding relationship of the user and the information of the terminal in the information server provided by the embodiment of the present disclosure.

TABLE 1

| User | Information of terminal | | | |
|---|---|---|---|---|
| A | a terminal | State | Ability | Equipment |
| | identifier | information | information | information |
| A | b terminal | State | Ability | Equipment |
| | identifier | information | information | information |
| A | c terminal | State | Ability | Equipment |
| | identifier | information | information | information |
| A | d terminal | State | Ability | Equipment |
| | identifier | information | information | information |
| B | a terminal | State | Ability | Equipment |
| | identifier | information | information | information |

In step 202, a file sent from another user is received, and a message of unread reminder is pushed to multiple terminals by the information server simultaneously, wherein the push message of the unread reminder carries a file.

The information server acquires that the user logs in multiple terminals according to identification information of the corresponding terminal stored in the table of corresponding relationship of the user and the information of the terminal. According to the corresponding relationship in the table 1, a user A corresponds to a terminal identifier a, a terminal identifier b, a terminal identifier c and a terminal identifier d respectively, so that receiving end of the user A have four terminals.

In step 203, a message of acquiring information of the current terminal is sent to the information server when the multiple terminals of the user receive the push message of unread reminder and the current terminal reads the push message.

In step 204, the information of the current terminal sent by the information server is received.

The user reads the push message with the current terminal such as the smart phone according to situations of self when multiple terminals receive the push message simultaneously. The information of the current terminal may be acquired from the information server.

In one embodiment of the present disclosure, the information of the terminal further includes information of the terminal's priority; the information server pushes a message to a terminal with highest priority firstly according to the information of the terminal's priority. In the case that the terminal with highest priority cannot effectively read the push message, the message may be pushed to terminals with lower priority in sequence.

In step 205, whether the current terminal is in an online state is determined by the information server according to the state information in the information of the current terminal, and step 206 is implemented if the current terminal is on an offline state; step 207 is implemented if the current terminal is on the online state.

In step 206, the push message is set as an offline message for the current terminal by the information server, unread reminder of the push message to other terminals is maintained, and turning back to a step 203.

In step 207, whether the file carried by the push message is effectively read by the current terminal is determined by the information server according to the information of the current terminal; if the file carried by the push message is effectively read by the current terminal, step 208 is implemented; if the file carried by the push message is not effectively read by the current terminal, step 209 is implemented.

That the file carried by the push message is effectively read by the current terminal includes two situations: 1, the current terminal has the capability of reading the file carried by the push message; or 2, the file carried by the push message is compulsively read by the current terminal.

Therefore, the information server determines whether the current terminal may effectively read the file carried by the push message according to the capability information of the current terminal and the information of the file carried by the push message.

The capability information may include types, formats, sizes and the like of files, which may be processed by the terminals, hardware information, software information, network information, and the like. The types of the files include: texts, voice, videos, graphs, package, emails, and the like; the formats include that when videos are taken as examples, suffixes of the videos shall be illustrated, such as *.avi *.rmvb *.rm *.asf *.divx *.mpg *.mpeg *.mpe *.wmv *.mp4 *.mkv *.vob and the like; except file sizes, other information of a format self shall be provided, such as corresponding word numbers of a text, corresponding time length of an audio/video, and the like. Hardware information includes a CPU, a hard disc/flash memory, remaining memory space, left power, and the like. Software information includes file processing capability of software brought by a system, file processing capability of installed software, and the like. Network information includes a wired network, a wireless network, and the like. When determining that the current terminal is capable of effectively reading the file carried by the push message, reading the file carried by the push message, and implementing a step 208.

When determining that the current terminal cannot effectively read the file carried by the push message, reminding whether the current terminal compulsively reads the file carried by the push message. In the case that the current terminal compulsively reads the file carried by the push message, the file carried by the push message is effectively read by the current terminal, so that the step 208 is implemented. In the case that the current terminal does not compulsively read the file carried by the push message, the file carried by the push message is not effectively read by the current terminal, so that a step 209 is implemented. What needs to be explained is that the step of reminding whether the current terminal compulsively reads the file carried by the push message may be executed by the terminal itself or executed by the terminal in response to some message or instruction sent from the information server.

In one embodiment of the present disclosure, when determining that the current terminal is not capable to effectively read the file carried by the push message, reminding whether the current terminal compulsively reads the file carried by the push message. After the current terminal processes the reminder (no matter whether the current terminal reads the file carried by the push message compulsively or does not read the file carried by the push message compulsively), feeding back a processing message to the information server so as to make the information server acquire the information of all terminals, selecting terminals which is capable to effectively read the file carried by the push message from all terminals according to the information of all terminal, maintaining the unread reminder to the terminals which may effectively read the file carried by the push message, and cancelling the unread reminder of the push message to other terminals, so as to increase the probability that the file carried by the push message is effectively read.

In step 208, the effectively-read identifier of the push message is fed back to the information server by the current terminal, so as to make the information server cancel the unread reminder of the push message to other terminals and ending the procedures.

In step 209, the unread reminder of the push message is maintained to other terminals by the information server.

In the embodiment of the present disclosure, as the file carried by the push message is not effectively read by the current terminal, the information server maintains the unread reminder of the push message to other terminals, and then other terminals may continuously read the file carried by the push message according to step 202 to step 209 till the file carried by the push message is effectively read by one of terminals.

In one embodiment of the present disclosure, according to the information of the current terminal, in the case that the file carried by the push message is not effectively read by the current terminal, the information server may further cancel the unread reminder of the push message to other terminals. Under the condition, the current terminal may copy the downloaded file carried by the push message into another terminal, which may effectively read the file, to be effectively read.

According to the solution, the information server determines whether the current terminal is on line to ensure that the push message is pushed to a terminal in the online state. Whether the current terminal may effectively read the file carried by the push message is determined, when the result is that the file carried by the push message may not be effectively read, whether the current terminal compulsively reads the file carried by the push message is reminded, and thus the user may independently choose whether to compulsively read the file carried by the push message with the current terminal. In addition, in the case that the file carried by the push message is compulsively read by the current terminal, information of all terminals may be acquired so as to ensure that the push message may be pushed to all terminals which may effectively read the push message, and thus effectively-read of the file carried by the push message is improved.

The solution of the present disclosure is described with the combination of the following living example.

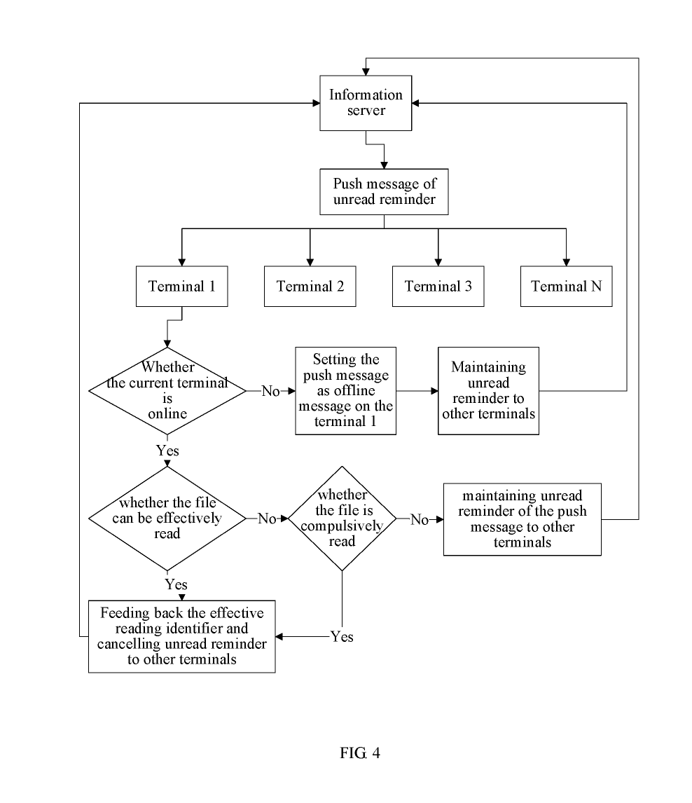

As shown in FIG. 4, if the user A receives a video sent from another user, the name of the video is “ABC”, the video format is *.avi”, and the video size is 500 MB.

In step 201 and step 202, the situation that the receiving end of the user A has four terminals is determined, that is, a terminal 1, a terminal 2, a terminal 3 and a terminal 4, and the information server pushes a message of unread reminder to the four terminals simultaneously.

According to step 203, the user firstly reads the push message with the terminal 1. The current terminal sends the message of acquiring the information of the current terminal to the information server.

According to step 204, step 205 and step 207, information of the current terminal from the information server is received, wherein the information of the current terminal includes: the remaining space of the current terminal is 1 GB, a video of which the file format is “*.avi” may be read, a current network is a wireless network, and the current terminal is in the online state. Therefore, the terminal 1 may effectively read the video carried by the push message and reads the video.

According to step 208, the effectively-read identifier of the push message is fed back to the information server to make the information server cancel the unread reminder to the terminal 2, the terminal 3 and the terminal 4.

If the terminal is in the offline state, the state is informed to the information server, and the information server sets the push message as an offline message on the terminal 1 and maintains the unread reminder to other terminals. If the terminal 1 is not capable to effectively read the video carried by the push message, whether to compulsively read the video carried by the push message with the terminal 1 is reminded to the user; if the user reads the video carried by the push message compulsively with the terminal 1, the effectively-read identifier is fed back to the information server, and the information server cancels the unread reminder to the terminal 2, the terminal 3 and the terminal 4; if the user does not read the video carried by the push message with the terminal 1, the message is informed to the information server, and the information server continuously maintains the unread reminder of the push message to the terminal 2, the terminal 3 and the terminal 4.

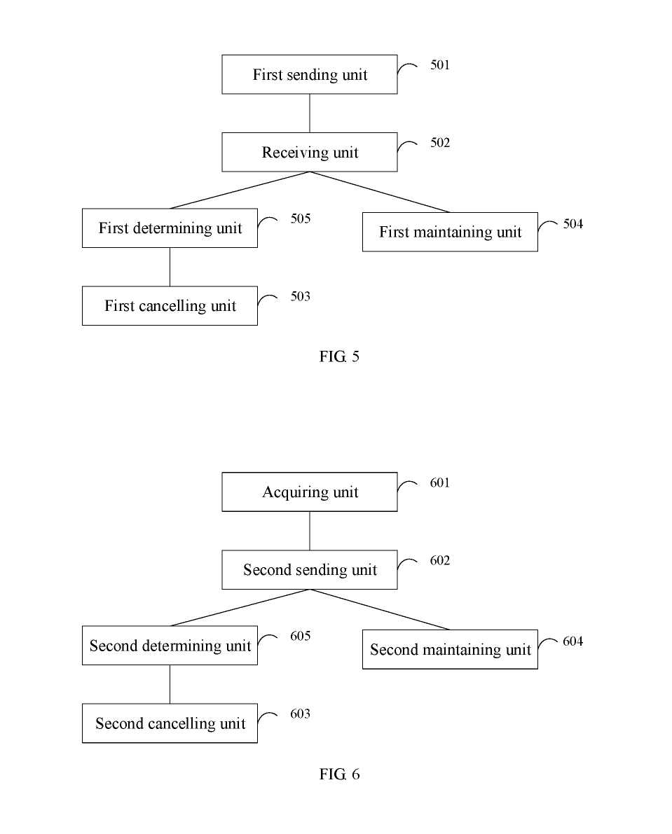

As shown in FIG. 5, the embodiment of the present disclosure further provides a device for pushing a message to multiple terminals, the device may be set in a terminal, including:

a first sending unit 501 configured to send a massage of acquiring information of a current terminal to an information server in the case that the current terminal reads a push message, wherein the push message carries a file;

a receiving unit 502 configured to receive information of the current terminal sent by the information sever;

when multiple terminals receive the push message at the same time, a user may read the push message with the current terminal such as a smart phone according to situation of self. The information of the current terminal is acquired from the information server.

In an embodiment of the present disclosure, the information of the terminal further includes information of a terminal's priority; the information server pushes the message to a terminal with highest priority according to the information of the terminal's priority. In the case that the terminal with the highest priority is not capable to effectively read the push message, the message may be pushed to terminals with lower priority in sequence.

A first canceling unit 503 configured to feed back an effectively-read identifier to the information server according to the received information of the current terminal in the case that the file carried by the push message is effectively read by the current terminal, so as to make the information server cancel unread reminder of the push message to other terminals.

Or, the device further includes: a first maintaining unit 504 configured to make the information server maintain the unread reminder of the push message to other terminals according to the received information of the current terminal in the case that the file carried by the push message is not effectively read by the current terminal.

The situation that the file carried by the push message is effectively read by the current terminal includes two situations: 1, the current terminal has the capability of reading the file carried by the push message; or 2, the file carried by the push message is compulsively read by the current terminal.

Therefore, whether the current terminal is capable to effectively read the file carried by the push message may be determined according to the capability information of the current terminal and the information of the file carried by the push message.

The capability information may include types, formats, sizes and the like of files, which may be processed by the terminals, hardware information, software information, network information, and the like. The types of the files include: texts, voice, videos, graphs, package, emails, and the like; the formats include that when videos are taken as examples, suffixes of the videos shall be illustrated, such as *.avi *.rmvb *.rm *.asf *.divx *.mpg *.mpeg *.mpe *.wmv *.mp4 *.mkv *.vob and the like; except file sizes, other information of a format self shall be provided, such as corresponding word numbers of a text, corresponding time length of an audio/video, and the like. Hardware information includes a CPU, a hard disc/flash memory, remaining memory space, left power, and the like. Software information includes file processing capability of software brought by a system, file processing capability of installed software, and the like. Network information includes a wired network, a wireless network, and the like. When determining that the current terminal may effectively read the file carried by the push message, the file carried by the push message is read, and the effectively-read identifier of the push message is fed back to the information server to make the information server cancel the unread reminder of the push message to other terminals.

When determining that the current terminal cannot effectively read the file carried by the push message, whether the current terminal compulsively reads the file carried by the push message is reminded. The situation wherein the current terminal compulsively reads the file carried by the push message means that the file carried by the push message is effectively read by the current terminal, so that the effectively-read identifier of the push message is fed back to the information server so as to make the information server cancel the unread reminder of the push message to other terminals. The situation wherein the current terminal does not compulsively read the file carried by the push message means that the file carried by the push message is not effectively read by the current terminal, so that the information server maintains the unread reminder of the push message to other terminals.

In the embodiment of the present disclosure, as the file carried by the push message is not effectively read by the current terminal, the information server maintains the unread reminder of the push message to other terminals, and then other terminals may continuously read the file carried by the push message till the file carried by the push message is effectively read by one terminal.

In one embodiment of the present disclosure, when the situation that the current terminal cannot effectively read the file carried by the push message is determined, whether the current terminal compulsively reads the file carried by the push message is reminded. After the current terminal processes the reminder (no matter whether the current terminal reads the file carried by the push message compulsively or does not read the file carried by the push message compulsively), a processing message is fed back to the information server so as to make the information server acquire the information of all terminals, the information server selects terminals which may effectively read the file carried by the push message from all terminals according to the information of all terminal, maintains the unread reminder to the terminals which may effectively read the file carried by the push message, and cancels the unread reminder of the push message to other terminals, thereby increasing the probability that the file carried by the push message is effectively read.

Or, the first canceling unit is specifically configured to feed back the effectively-read identifier to the information server according to the received information of the current terminal under the conditions that the current terminal has the capability of reading the file carried by the push message and the file carried by the push message is effectively read by the current terminal, so as to make the information server cancel the unread reminder of the push message to other terminals;

or,

according to the received information of the current terminal, under the condition that the current terminal has no capability of reading the file carried by the push message, remind whether the current terminal reads the file carried by the push message compulsively;

after the reminder is processed by the current terminal, feedback a processing message to the information server so as to make the information server acquire the information of all terminals, select terminals which may effectively read the file carried by the push message from all terminals according to the information of all terminal, maintain the unread reminder to the terminals which may effectively read the file carried by the push message, and cancel the unread reminder of the push message to other terminals;

or,

The information of the current terminal includes state information and capability information, wherein the capability information is used for indicating whether the current terminal has the capability of processing the file carried by the push message;

The device further includes:

before feeding back the effectively-read identifier to the information server under the condition that the file carried by the push message is effectively read by the current terminal so as to make the information server cancel the unread reminder of the push message to other terminals, a first determining unit 505 configured to send the state information and the capability information to the information server so as to make the information server determine whether the current terminal is in the online state according to the state information of the current terminal; if the current terminal is in the offline state, set the push message as the offline message for the current terminal, continuously maintain the unread reminder of the push message to other terminals; if the current terminal is in the online state, further determine whether the current terminal may effectively read the file carried by the push message according to the capability information of the current terminal.

The device for pushing the message to multiple terminals in the embodiment is used for achieving the methods in the terminals to push the message to multiple terminals in multiple embodiments, and has beneficial effects of corresponding methods in the embodiments, and here the beneficial effects are not described repeatedly.

As shown in FIG. 6, the embodiment of the present disclosure further provides a device for pushing the message to multiple terminals; the device may be set in an information server, including:

an acquiring unit 601 configured to acquire a message, which is sent from a current terminal when reading a push message for acquiring information of the current terminal, wherein the push message carries a file;

a second sending unit 602 configured to send the information of the current terminal to the current terminal;

a second canceling unit 603 configured to receive an effectively-read identifier fed back from the current terminal, and cancel unread reminder of the push message to other terminals, wherein the effectively-read identifier is fed back to the information server from the current terminal according to the received information of the current terminal in the case that the file carried by the push message is effectively read by the current terminal.

Or, the device of the embodiment further includes: a second maintaining unit 604 configured to maintain the unread reminder of the push message to other terminals when receiving an ineffectively read identifier fed back from the current terminal, wherein the ineffectively read identifier is fed back to the information server from the current terminal according to the received information of the current terminal under the condition that the file carried by the push message is not effectively read by the current terminal.

Or, the situation that the file carried by the push message is effectively read by the current terminal includes the current terminal has the capability of reading the file carried by the push message; or the file carried by the push message is compulsively read by the current terminal.

Or, the second canceling unit 603 is specifically configured to receive the effectively-read identifier fed back from the current terminal, and cancel the unread reminder of the push message to other terminals, wherein the effectively-read identifier is fed back to the information server from the current terminal according to the received information of the current terminal under the condition that the current terminal has the capability of reading the file carried by the push message and the file carried by the push message is effectively read by the current terminal; or remind whether the current terminal compulsively reads the file carried by the push message when the situation that the current terminal has no capability of reading the file carried by the push message is determined according to the information fed back from the current terminal; after the processing message fed back after the current terminal processes the reminder is received, acquire information of all terminals, select terminals which may effectively read the file carried by the push message from all terminals according to the information of all terminals, maintain the unread reminder to terminals which may effectively read the file of the push message, and cancel the unread reminder of the push message to other terminals.

Or, the information of the current terminal includes: state information and capability information, wherein the capability information is used for indicating whether the current terminal has the capability of processing the file carried by the push message; the device of the embodiment further includes: a second determining unit 605 configured to receive state information and capability information sent from the current terminal before the second canceling unit 603 receives the effectively-read identifier fed back from the current terminal and cancels the unread reminder of the push message to other terminals; determine whether the current terminal is in an online state according to the state information of the current terminal; if the current terminal is in an offline state, set the push message as an offline message for the current terminal, and maintain the unread reminder of the push message to other terminals; if the current terminal is in the online state, further determine whether the current terminal may effectively read the file carried by the push message according to the capability information of the current terminal.

The device for pushing the message to multiple terminals in the embodiment is used for achieving the methods in the information server to push the message to multiple terminals in multiple embodiments, and has beneficial effects of corresponding methods in the embodiments, and here the beneficial effects are not described repeatedly.

Common technicians of the field may understand that total or partial steps of the methods in the embodiments above may be achieved by hardware related to program instructions, the programs may be stored in one computer readable storage medium, and when being used, the programs are enabled to execute the steps of the methods of the embodiments; the storage medium mentioned above may be various mediums such as an ROM, an RAM, a magnetic disc or an optical disc for storing program codes.

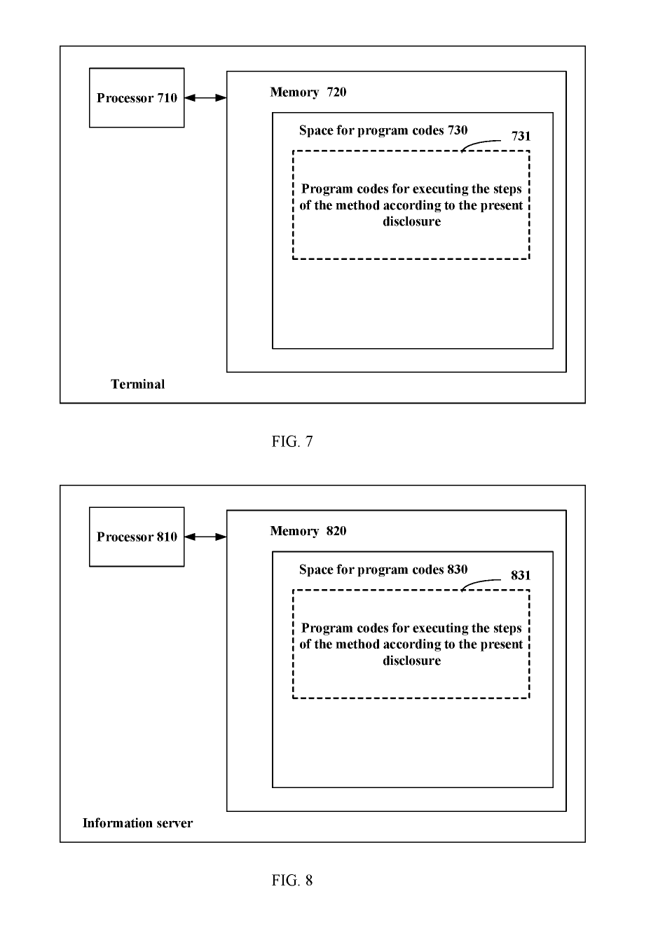

For example, FIG. 7 illustrates a block diagram of an electronic device for executing the method according the disclosure. The electronic device may be the terminal above. Traditionally, the electronic device includes a processor 710 and a computer program product or a computer readable medium in form of a memory 720. The memory 720 could be electronic memories such as flash memory, EEPROM (Electrically Erasable Programmable Read-Only Memory), EPROM, hard disk or ROM. The memory 720 has a memory space 730 for executing program codes 731 of any steps in the above methods. For example, the memory space 730 for program codes may include respective program codes 731 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells. The memory cells may be provided with memory sections, memory spaces, etc. The program codes may be compressed for example in an appropriate form. Usually, the memory cell includes computer readable codes which can be read for example by processors 710. When these codes are operated on the server, the server may execute respective steps in the method as described above.

In addition, FIG. 8 illustrates a block diagram of an electronic device for executing the method according the disclosure. The electronic device may be the information server above. Traditionally, the electronic device includes a processor 810 and a computer program product or a computer readable medium in form of a memory 820. The memory 820 could be electronic memories such as flash memory, EEPROM (Electrically Erasable Programmable Read-Only Memory), EPROM, hard disk or ROM. The memory 820 has a memory space 830 for executing program codes 831 of any steps in the above methods. For example, the memory space 830 for program codes may include respective program codes 831 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells. The memory cells may be provided with memory sections, memory spaces, etc. The program codes may be compressed for example in an appropriate form. Usually, the memory cell includes computer readable codes which can be read for example by processors 810. When these codes are operated on the server, the server may execute respective steps in the method as described above.

The final description is that the embodiments are only used for describing the technical solution of the present disclosure but not for limiting. Although the present disclosure is specifically described with reference to the embodiments, common technicians of the field shall understand that the technical solution recorded by each of the embodiments may be modified, or one part of technical characteristics may be equivalently replaced, and the modification or replacement does not enable the essence of the corresponding technical solution to get out of the spirit and scope of the technical solution in each embodiment of the present disclosure.

What is claimed is:

1. A multi-terminal-based message pushing method, comprising:
in the case of reading a push message, sending, by a current terminal, a message of acquiring information of the current terminal to an information server, wherein the push message carries a file;
receiving information of the current terminal sent by the information server;
feeding back an effectively-read identifier to the information server according to the received information of the current terminal in the case that the file carried by the push message is effectively read by the current terminal, so as to make the information server cancel an unread reminder of the push message to other terminals.

2. The method according to the claim 1, further comprising:
according to the received information of the current terminal, making the information server maintain the unread reminder of the push message to other terminals by the current terminal when the file carried by the push message is not effectively read by the current terminal.

3. The method according to the claim 1, wherein the file carried by the push message is effectively read by the current terminal comprises: the current terminal is capable of reading the file carried by the push message; or
the file carried by the push message is compulsively read by the current terminal.

4. The method according to the claim 3, wherein feeding back the effectively-read identifier to the information server according to the received information of the current terminal in the case that the file carried by the push message is effectively read by the current terminal, so as to make the information server cancel unread reminder of the push message to other terminals comprises:
feeding back the effectively-read identifier to the information server by the current terminal according to the received information of the current terminal when the current terminal is capable of effectively reading the file carried by the push message and the file carried by the push message is effectively read by the current terminal, so as to make the information server cancel the unread reminder of the push message to other terminals; or
reminding the current terminal whether to compulsively reads the file carried by the push message according to the received information of the current terminal when the current terminal has no capability of reading the file carried by the push message;
feeding back a processing message to the information server after the current terminal processes the reminder so as to make the information server acquire information of all terminals, selecting terminals which have a capability of effectively reading the file carried by the push message from all terminals according to the information of all terminals, maintaining the unread reminder for the terminals which have the capability of effectively reading the file carried by the push message, and cancelling the unread reminder of the push message to other terminals.

5. The method according to the claim 1, wherein the information of the current terminal comprises: state information and capability information, wherein the capability information is used for indicating whether the current terminal has the capability of processing the file carried by the push message;
the file carried by the push message is effectively read by the current terminal and the current terminal feeds back the effectively-read identifier to the information server, so as to make the information server cancel the unread reminder of the push message to other terminals, before which the method further comprising:
sending the state information and the capability information to the information server by the current terminal so as to make the information server determine whether the current terminal is in an online state according to the state information of the current terminal; if the current terminal is in an offline state, setting the push message as an offline message for the current terminal, and maintaining the unread reminder of the push message to other terminals; if the current terminal is in the online state, further determining whether the current terminal is capable of effectively reading the file carried by the push message according to the capability information of the current terminal.

6. An electronic device for multi-terminal-based message pushing device comprising:
at least one first processor; and
a first memory communicably connected with the at least one first processor for storing instructions executable by the at least one first processor, wherein execution of the instructions by the at least one first processor causes the at least one first processor to:
send a message of acquiring information of a current terminal to an information server when the current terminal is reading a push message, wherein the push message carries a file;
receive the information of the current terminal sent by the information server;
feed back an effectively-read identifier to the information server according to the received information of the current terminal in the case that the file carried by the push message is effectively read by the current terminal, so as to make the information server cancel unread reminder of the push message to other terminals.

7. The electronic device according to the claim 6, wherein execution of the instructions by the at least one first processor causes the at least one first processor to further:
make the information server maintain the unread reminder of the push message to other terminals according to the received information of the current terminal when the file carried by the push message is not effectively read by the current terminal.

8. The electronic device according to the claim 6, wherein the file carried by the push message is effectively read by the current terminal comprises: the current terminal is capable of reading the file carried by the push message; or
the file carried by the push message is compulsively read by the current terminal.

9. The electronic device according to the claim 8, wherein feeding back an effectively-read identifier to the information server according to the received information of the current terminal in the case that the file carried by the push message is effectively read by the current terminal, so as to make the information server cancel unread reminder of the push message to other terminals comprises: feedback the effectively-read identifier to the information server according to the received information of the current terminal when the current terminal has a capability of reading the file carried by the push message and the file carried by the push message is effectively read by the current terminal, so as to make the information server cancel the unread reminder of the push message to other terminals;
or
remind the current terminal whether to compulsively reads the file carried by the push message according to the received information of the current terminal when the current terminal has no capability of reading the file carried by the push message;
feedback a processing message to the information server after the current terminal processes the reminder so as to make the information server acquire information of all terminals, select terminals which have the capability of effectively reading the file carried by the push message from all terminals according to the information of all terminals, maintain the unread reminder for the terminals which have the capability of effectively reading the file carried by the push message, and cancel the unread reminder of the push message to other terminals.

10. The electronic device according to the claim 6, wherein the information of the current terminal comprises: state information and capability information, wherein the capability information is configured to indicate whether the current terminal has a capability of processing the file carried by the push message;
execution of the instructions by the at least one first processor causes the at least one first processor to further:
the file carried by the push message is effectively read by the current terminal and the current terminal feeds back the effectively-read identifier to the information server, so as to make the information server cancel the unread reminder of the push message to other terminals, before which, send the state information and the capability information to the information server by the current terminal so as to make the information server determine whether the current terminal is in an online state according to the state information of the current terminal, if the current terminal is in an offline state, set the push message as an offline message for the current terminal, and maintain the unread reminder of the push message to other terminals; if the current terminal is in the online state, further determine whether the file carried by the push message is capable of being effectively read by the current terminal according to the capability information of the current terminal.

11. A multi-terminal-based message pushing method, comprising:
acquiring, by an information server, a message which is sent from a current terminal when reading a push message for acquiring information of the current terminal, wherein the push message carries a file;
sending, by the information server, information of the current terminal to the current terminal;
receiving, by the information server, an effectively-read identifier fed back from the current terminal, and cancelling unread reminder of the push message to other terminals, wherein the effectively-read identifier is fed back to the information server from the current terminal according to the received information of the current terminal in the case that the file carried by the push message is effectively read by the current terminal.

12. The method according to the claim 11, further comprising:
maintaining the unread reminder of the push message to other terminals by the information server when receiving an ineffectively read identifier fed back from the current terminal, wherein the ineffectively read identifier is fed back to the information server from the current terminal according to the received information of the current terminal when the file carried by the push message is not effectively read by the current terminal.

13. The method according to the claim 11, wherein the file carried by the push message is effectively read comprises: the current terminal is capable of reading the file carried by the push message; or
the file carried by the push message is compulsively read by the current terminal.

14. The method according to the claim 13, wherein receiving, by the information server, the effectively-read identifier fed back from the current terminal and cancelling the unread reminder of the push message to other terminals comprises:
receiving, by the information server, the effectively-read identifier fed back from the current terminal and canceling the unread reminder of the push message to other terminals, wherein the effectively-read identifier is fed back to the information server from the current terminal according to the received information of the current terminal when the current terminal has a capability of reading the file carried by the push message and the file carried by the push message is effectively read by the current terminal;
or,
confirming that the current terminal has no capability of reading the file carried by the push message according to the information fed back from the current terminal, reminding the current terminal whether to compulsively reads the file carried by the push message by the information server;
acquiring information of all terminals by the information server after receiving a processing message fed back from the current terminal after processing the reminder, selecting terminals which have the capability of effectively reading the file carried by the push message from all terminals according to the information of all terminals, maintaining the unread reminder to the terminals which have the capability of effectively reading the file carried by the push message, and cancelling the unread reminder of the push message to other terminals.

15. The method according to the claim 11, wherein
the information of the current terminal comprises state information and capability information, wherein the capability information is configured to indicate whether the current terminal has a capability of processing the file carried by the push message;
before receiving the effectively-read identifier fed back from the current terminal and canceling the unread reminder of the push message to other terminals, the method further comprising:
receiving the state information and the capability information sent from the current terminal by the information server, determining whether the current terminal is in an offline state according to the state information of the current terminal, if the current terminal is in the offline state, setting the push message as an offline message for the current terminal, maintaining the unread reminder of the push message to other terminals, and if the current terminal is in an online state, further determining whether the current terminal is capable of effectively reading the file carried by the push message according to the capability information of the current terminal.

16. An electronic device for multi-terminal-based message pushing, comprising:
at least one second processor; and
a second memory communicably connected with the at least one second processor for storing instructions executable by the at least one second processor, wherein execution of the instructions by the at least one second processor causes the at least one second processor to:
acquire a message sent from a current terminal when reading a push message for acquiring information of the current terminal, wherein the push message carries a file;
send the information of the current terminal to the current terminal;
receive an effectively-read identifier fed back from the current terminal, and cancel unread reminder of the push message to other terminals, wherein the effectively-read identifier is fed back to the information server from the current terminal according to the received information of the current terminal in the case that the file carried by the push message is effectively read by the current terminal.

17. The electronic device according to the claim 16, wherein execution of the instructions by the at least one second processor causes the at least one second processor to further:
maintain the unread reminder of the push message to other terminals when receiving an ineffectively read identifier fed back from the current terminal, wherein the ineffectively read identifier is fed back to the information server from the current terminal according to the received information of the current terminal when the file carried by the push message is not effectively read by the current terminal.

18. The electronic device according to the claim 16, wherein the file carried by the push message is effectively read by the current terminal comprises: the current terminal is capable of reading the file carried by the push message; or
the file carried by the push message is compulsively read by the current terminal.

19. The electronic device according to the claim 18, wherein execution of the instructions by the at least one second processor causes the at least one second processor to further:
receive the effectively-read identifier fed back from the current terminal, and cancel the unread reminder of the push message to other terminals, wherein the effectively-read identifier is fed back to the information server from the current terminal according to the received information of the current terminal when the current terminal has a capability of reading the file carried by the push message and the file carried by the push message is effectively read by the current terminal;
or
remind whether the current terminal compulsively reads the file carried by the push message when determining that the current terminal has no capability of reading the file carried by the push message according to the information fed back from the current terminal;
acquire information of all terminals after receiving a processing message fed back from the current terminal after processing the reminder, select terminals which have the capability of effectively reading the file carried by the push message from all terminals according to the information of all terminals, maintain the unread reminder to the terminals which have the capability of effectively reading the file carried by the push message, and cancel the unread reminder of the push message to other terminals.

20. The electronic device according to the claim 16, wherein the information of the current terminal comprises: state information and capability information, wherein the capability information is configured to indicate whether the current terminal has a capability of processing the file carried by the push message;
execution of the instructions by the at least one second processor causes the at least one second processor to further:
before the second canceling unit receives the effectively-read identifier fed back from the current terminal and cancels the unread reminder of the push message to other terminals, receive the state information and the capability information sent from the current terminal, determine whether the current terminal is in an online state according to the state information of the current terminal, if the current terminal is in an offline state, set the push message as an offline message for the current terminal, and maintain the unread reminder of the push message to other terminals; if the current terminal is in the online state, further determine whether the current terminal is capable of effectively reading the file carried by the push message according to the capability information of the current terminal.
